(19) United States
(12) Patent Application Publication
(10) Pub. No.: US 2026/0139801 A1
(43) Pub. Date: May 21, 2026

(54) IOT SYSTEMS AND METHODS FOR REMOTE CONTROL AND SUPERVISION OF VALVES IN SMART GAS PIPELINE NETWORK

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Feng WANG, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 19/448,135

(22) Filed: Jan. 14, 2026

(30) Foreign Application Priority Data
Nov. 18, 2025 (CN) 202511687049.3

(51) Int. Cl. F17D 5/00; F17D 3/01; G06Q 50/06

(52) U.S. Cl. CPC F17D 5/005; F17D 3/01; G06Q 50/06

(57) ABSTRACT

An IoT system and a method for remote control supervision of valves in a smart gas pipeline network are provided. The method includes: obtain pipeline network information and a performance parameter of the at least one control component and upload the performance parameter; in response to obtaining a parameter confirmation instruction, determine deployment parameters based on the pipeline network information and the performance parameter, and upload the deployment parameters to the government safety supervision management platform; in response to obtaining a deployment confirmation instruction, and send the deployment parameters to the gas maintenance object platform; after completing the deployment, determine a regulation compensation quantity of the at least one control component based on a correction period, and upload the regulation compensation quantity to the government safety supervision management platform; in response to obtaining a correction confirmation instruction, correct the at least one control component based on the regulation compensation quantity.

### CROSS-REFERENCE TO RELATED APPLICATIONS

This application claims priority of Chinese Application No. 202511687049.3 filed on Nov. 18, 2025, the contents of which are hereby incorporated by reference in its entirety.

### TECHNICAL FIELD

The present disclosure relates to the field of smart gas control, and in particular, to an internet of things (IoT) system and a method for remote control and supervision of valves in a smart gas pipeline network.

### BACKGROUND

A gas pipeline is a main carrier for transporting gas. To ensure safety of gas operation, in a design of a gas pipeline network, pipeline valves are typically deployed at various pipeline network nodes to control transmission and switching of gas. Remote control component is additionally installed to achieve remote control of the pipeline valves, thereby enabling remote regulation of the valves in case of a gas accident to reduce gas leakage time and lower safety risks.

Since the control component of a pipeline valve has a maximum communication distance, a reasonable installation position of the control component and a pairing relationship with the valve need to be determined before installation to ensure effective coverage of the valve by the control component. Furthermore, after installation is completed and during use, an error assessment of an actual regulation result of the control component is required to timely perform correction to ensure effectiveness of the remote control.

Therefore, it is necessary to provide an internet of things (IoT) system and a method for remote control and supervision of valves in a smart gas pipeline network, which may reasonably determine a deployment position of the control component to cover a valve, while accurately assessing a regulation deviation and performing timely correction, to ensure accuracy and effectiveness of remote control supervision of the valve, thereby improving an intelligent monitoring and control level of the gas pipeline network.

### SUMMARY

One or more embodiments of the present disclosure provide an IoT system for remote control and supervision of valves in a smart gas pipeline network, wherein the IoT system includes a government safety supervision management platform, a government safety supervision sensor network platform, a government safety supervision object platform, a gas company sensor network platform, a gas equipment object platform, and a gas maintenance object platform; wherein the government safety supervision object platform includes a gas company management platform, the gas equipment object platform includes at least one control component, and the gas maintenance object platform includes at least one personnel interaction device; wherein the gas company management platform is configured to execute a method for remote control and supervision of valves in a smart gas pipeline network.

One or more embodiments of the present disclosure provide a method for remote control and supervision of valves in a smart gas pipeline network, wherein the method is implemented based on an IoT system for remote control and supervision of valves in a smart gas pipeline network, the IoT system including a government safety supervision management platform, a government safety supervision sensor network platform, a government safety supervision object platform, a gas company sensor network platform, a gas equipment object platform, and a gas maintenance object platform; wherein the government safety supervision object platform includes a gas company management platform, the gas equipment object platform includes at least one control component, and the gas maintenance object platform includes at least one personnel interaction device; wherein the method is performed by the gas company management platform and comprises: obtain pipeline network information and a performance parameter of the at least one control component from the gas equipment object platform via the gas company sensor network platform, and upload the performance parameter to the government safety supervision management platform via the government safety supervision sensor network platform; in response to obtaining a parameter confirmation instruction issued by the government safety supervision management platform, determine deployment parameters based on the pipeline network information and the performance parameter, and upload the deployment parameters to the government safety supervision management platform via the government safety supervision sensor network platform; wherein the deployment parameters includes at least one deployment position and at least one covered valve of at least one control component; in response to obtaining a deployment confirmation instruction issued by the government safety supervision management platform, send the deployment parameters to the gas maintenance object platform via the gas company sensor network platform, to arrange a staff member for component deployment; after completing the deployment, determine a regulation compensation quantity of the at least one control component based on a correction period, and upload the regulation compensation quantity to the government safety supervision management platform via the government safety supervision sensor network platform; and in response to obtaining a correction confirmation instruction issued by the government safety supervision management platform, correcting the at least one control component based on the regulation compensation quantity; wherein the determining a regulation compensation quantity of the at least one control component based on a correction period includes: within the correction period, performing the following operations: controlling, based on a regulation parameter group, the at least one control component to regulate the at least one covered valve, to obtain a regulation gas data pair; and determining the regulation compensation quantity based on the regulation gas data pair and the regulation parameter group.

One or more embodiments of the present disclosure provide a non-transitory computer-readable storage medium, wherein the storage medium stores computer instructions, and when a computer reads the computer instructions in the storage medium, the computer executes the method for remote control and supervision of valves in a smart gas pipeline network.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary platform structure of an IoT system for remote control and supervision of valves in a smart gas pipeline network according to some embodiments of the present disclosure;

FIG. 2 is a flowchart illustrating an exemplary process for remote control and supervision of valves in a smart gas pipeline network according to some embodiments of the present disclosure;

FIG. 3 is an exemplary schematic diagram of determining deployment parameters according to some embodiments of the present disclosure; and

FIG. 4 is an exemplary schematic diagram of determining a regulation compensation quantity according to some embodiments of the present disclosure.

### DETAILED DESCRIPTION

The drawings required for describing the embodiments are briefly introduced below. The drawings do not represent all embodiments. The terms “system,” “device,” “unit,” and/or “module” used in the present disclosure are a method for distinguishing components, elements, parts, sections, or assemblies of different levels. If other words can achieve the same purpose, the words may be replaced by other expressions.

As shown in the present disclosure, unless the context clearly indicates an exception, the terms “a,” “an,” “one,” and/or “the” are not specifically singular and may also include plural. Generally, the terms “include” and “contain” only indicate inclusion of explicitly identified steps and elements, and these steps and elements do not constitute an exclusive list; a method or a device may also include other steps or elements.

In the embodiments of the present disclosure, when describing operations performed step by step, unless otherwise specified, the order of the steps is adjustable, steps may be omitted, and other steps may also be included during the operation.

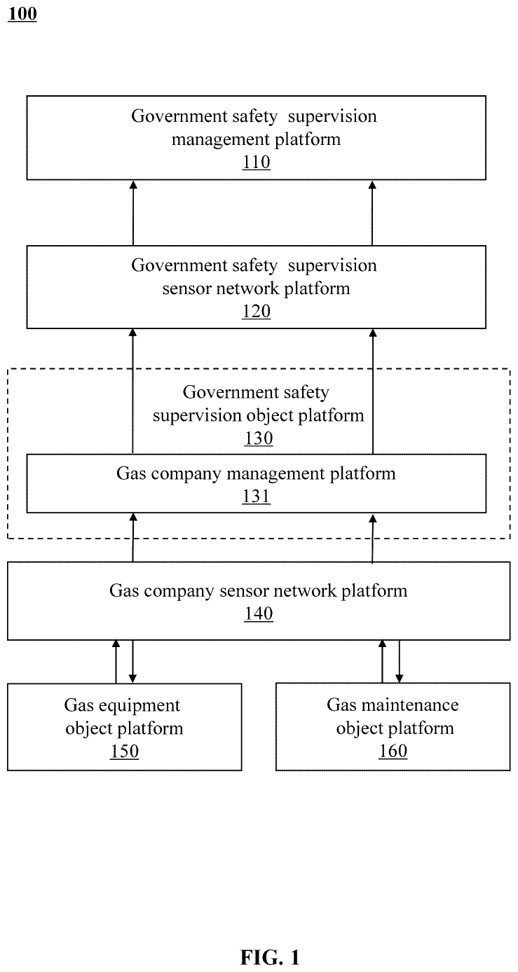

FIG. 1 is a schematic diagram illustrating an exemplary platform structure of an IoT system for remote control and supervision of valves in a smart gas pipeline network according to some embodiments of the present disclosure.

In some embodiments, as shown in FIG. 1, an IoT system 100 for remote control and supervision of valves in a smart gas pipeline network may include a government safety supervision management platform 110, a government safety supervision sensor network platform 120, a government safety supervision object platform 130, a gas company sensor network platform 140, a gas equipment object platform 150, and a gas maintenance object platform 160. The government safety supervision object platform 130 may include a gas company management platform 131, the gas equipment object platform 150 may include at least one control component, and the gas maintenance object platform 160 may include at least one personnel interaction device.

The government safety supervision management platform 110 refers to a platform for government safety supervision and management, and the government safety supervision management platform 110 may be configured as a processor and/or a server.

In some embodiments, the government safety supervision management platform 110 may be communicatively connected to the gas company management platform 131 through the government safety supervision sensor network platform 120.

The government safety supervision sensor network platform 120 refers to a platform for government safety supervision and management of sensor network information, and the government safety supervision sensor network platform 120 may be configured as a communication device and/or a server.

The government safety supervision object platform 130 refers to an object platform for generating sensing information and executing control information, and the government safety supervision object platform 130 may be configured as a processor and/or a server. In some embodiments, the government safety supervision object platform 130 may include the gas company management platform 131.

The gas company management platform 131 refers to a comprehensive management platform for information related to a gas company, and the gas company management platform 131 may be configured as a processor and/or a server and a memory.

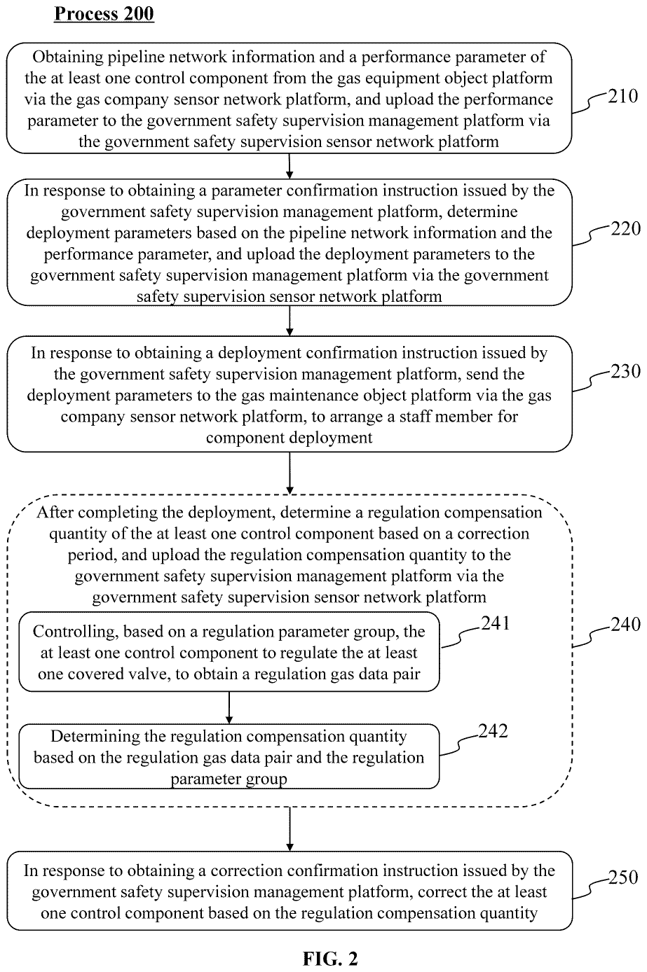

In some embodiments, the gas company management platform 131 may be configured to execute a method for remote control and supervision of valves in a smart gas pipeline network. More descriptions regarding the method may be found in the related description of FIG. 2.

The gas company sensor network platform 140 refers to a comprehensive management platform for sensor information of a gas company, and the gas company sensor network platform 140 may be configured as a communication device and/or a server. In some embodiments, the gas company sensor network platform 140 may be used for communication interaction between the gas company management platform 131 and the gas equipment object platform 150 and the gas maintenance object platform 160.

The gas equipment object platform 150 refers to a functional platform for real-time remote regulation of a gas pipeline network. In some embodiments, the gas equipment object platform 150 may include the at least one control component.

The control component refers to a component for remotely controlling valves in a pipeline network. In some embodiments, one control component may remotely regulate one or more valves on a gas pipeline, and control of gas transmission in the pipeline may be achieved by controlling an opening degree of a valve.

A process of regulating the valve by the at least one control component may include adjusting the opening degree of the valve from the current initial opening degree to an expected opening degree, and after monitoring gas data, restoring the opening degree of the valve to the initial opening degree. The expected opening degree may be preset manually according to actual situations.

The gas maintenance object platform 160 refers to a platform for interacting with gas users. The gas users refer to persons related to gas use. For example, the gas users include individuals using gas, enterprises, staff members of the gas pipeline network (e.g., component installers, pipeline monitors), etc. The gas maintenance object platform 160 may include the at least one personnel interaction device. For example, the gas maintenance object platform 160 includes mobile phones, computers, etc.

In some embodiments, the IoT system 100 for remote control and supervision of valves in the smart gas pipeline network may further include a processor. The processor may process data and/or information related to the IoT system 100 for remote control and supervision of valves in the smart gas pipeline network. The processor may execute program instructions based on the data, the information, and/or processing results to perform one or more functions described in the present disclosure. In some embodiments, the processor may include one or more sub-processing devices (e.g., single-core processing devices, multi-core multi-chip processing devices, etc.). Merely by way of example, the processor may include a central processing unit (CPU), an application-specific integrated circuit (ASIC), or the like, or any combination thereof.

In some embodiments, the processor may interact with a plurality of platforms included in the IoT system 100 for remote control and supervision of valves in the smart gas pipeline network. The processor may also be configured in the plurality of platforms.

In some embodiments of the present disclosure, based on the IoT system for remote control and supervision of valves in the smart gas pipeline network, an information operation closed loop may be formed among various functional platforms. Under unified management of the gas company management platform, the functional platforms may operate in a coordinated and regular manner, achieving informatization and intelligence for remote control and supervision of valves in the smart gas pipeline network.

FIG. 2 is a flowchart illustrating an exemplary process of a method for remote control and supervision of valves in a smart gas pipeline network according to some embodiments of the present disclosure.

In some embodiments, a process 200 may be implemented based on the IoT system 100 for remote control and supervision of valves in the smart gas pipeline network. The process 200 may be performed by the gas company management platform 131 in the IoT system 100. As another example, the process 200 may be performed by a processor in the gas company management platform 131. As shown in FIG. 2, the process 200 includes following steps.

Step 210, obtaining pipeline network information and a performance parameter of the at least one control component from the gas equipment object platform via the gas company sensor network platform, and uploading the performance parameter to the government safety supervision management platform via the government safety supervision sensor network platform.

The pipeline network information refers to information related to a gas pipeline network of a current area. The pipeline network information may include a valve position. A valve may be a control valve deployed inside a gas pipeline in the current area to control a flow rate, a flow velocity, a pressure, etc., of gas in the gas pipeline. The valve position may be represented by position coordinates, etc.

The current area refers to an area where deployment of the at least one control component is currently required. One or more control components need to be deployed in the current area. Each control component may control one or more valves. In some embodiments, control components required to be deployed in the current area are control components with a same performance parameter.

The performance parameter may include a maximum communication distance and a maximum valve connection count.

The maximum communication distance refers to a maximum distance over which the at least one control component may communicate with valves.

The maximum valve connection count refers to a maximum count of the valves that the at least one control component may communicatively connect to. The at least one control component may control the valves communicatively connected to the at least one control component.

In some embodiments, the gas equipment object platform may obtain the performance parameter of the at least one control component based on factory parameters of the at least one control component, and obtain the pipeline network information based on installation records. The gas company management platform may obtain the pipeline network information and the performance parameter of the at least one control component from the gas equipment object platform via the gas company sensor network platform, and upload the performance parameter to the government safety supervision management platform via the government safety supervision sensor network platform. The government safety supervision management platform may confirm the performance parameter.

Step 220, in response to obtaining a parameter confirmation instruction issued by the government safety supervision management platform, determining deployment parameters based on the pipeline network information and the performance parameter, and uploading the deployment parameters to the government safety supervision management platform via the government safety supervision sensor network platform.

The parameter confirmation instruction refers to an instruction confirming that the performance parameter is correct.

In some embodiments, the parameter confirmation instruction may be generated after the government safety supervision management platform confirms the performance parameter, and the parameter confirmation instruction may be issued to the gas company management platform via the government safety supervision sensor network platform.

The deployment parameters may include at least one deployment position and at least one covered valve of the at least one control component.

The deployment position refers to a position where the control component is deployed. The deployment position may be represented by position coordinates, etc.

The covered valves refer to valves that the control component may control under the deployment position. A distance between a valve position of the covered valve and the deployment position of the at least one control component is less than a maximum communication distance of the at least one control component.

In some embodiments, the processor may determine the deployment parameters based on the pipeline network information and the performance parameter in various ways.

Merely by way of example, the processor may construct a plurality of first reference vectors based on pipeline network information of a plurality of other areas and the performance parameter of at least one control component in the other areas. The processor may construct a first feature vector based on the pipeline network information of the current area and the performance parameter of the at least one control component. The processor may determine a first reference vector having a greatest vector similarity with the first feature vector and use the first reference vector as a first target vector. The processor may perform equivalent processing on an area corresponding to the first target vector and the current area, and project actual deployment parameters of the area corresponding to the first target vector onto the current area as the deployment parameters of the current area. The other areas refer to areas where deployment of the at least one control component has been completed. Manners for the equivalent processing may include coordinate system overlap, etc.

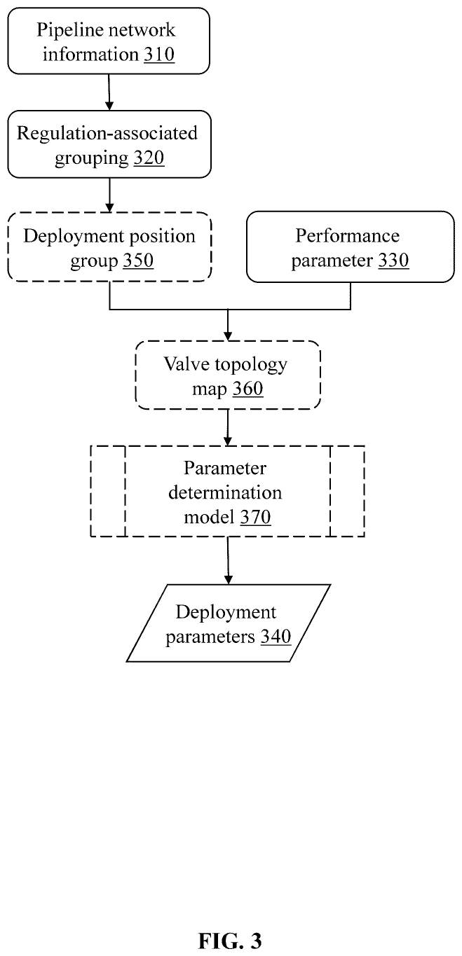

In some embodiments, the processor may also determine a regulation-associated grouping based on the pipeline network information; and determine the deployment parameters based on the regulation-associated grouping and the performance parameter of the at least one control component. More descriptions regarding this part may be found in FIG. 3 and related descriptions thereof.

Step 230, in response to obtaining a deployment confirmation instruction issued by the government safety supervision management platform, sending the deployment parameters to the gas maintenance object platform via the gas company sensor network platform, to arrange a staff member for component deployment.

The deployment confirmation instruction refers to an instruction for confirming component deployment according to the deployment parameters. In some embodiments, the deployment confirmation instruction may be generated after the government safety supervision management platform confirms the deployment parameters, and the deployment confirmation instruction may be issued to the gas company management platform via the government safety supervision sensor network platform.

In some embodiments, after obtaining the deployment confirmation instruction, the gas company management platform may send the deployment parameters to the gas maintenance object platform via the gas company sensor network platform. The staff member may obtain the deployment parameters through the personnel interaction device and deploy the at least one control component according to the deployment parameters.

Step 240, after completing the deployment, determining a regulation compensation quantity of the at least one control component based on a correction period, and uploading the regulation compensation quantity to the government safety supervision management platform via the government safety supervision sensor network platform.

The correction period refers to a time interval for periodically correcting the at least one control component.

In some embodiments, due to a fault of the at least one control component or a fault of the valve (e.g., a calibration fault of the at least one control component, rust of the valve, or the like), an offset degree may exist during a process of regulating the valve by the at least one control component.

The offset degree refers to a regulation deviation of the valve. The offset degree may be represented by a difference obtained by subtracting an expected opening degree from an actual opening degree of the covered valves after regulation by the at least one control component. The regulation compensation quantity refers to a quantity for compensating for the offset degree during the process of regulating the valve by the at least one control component. For example, an expected opening degree of a valve is 20°, and an actual opening degree after regulation is 18°. An offset degree of the valve is −2°. Therefore, the expected opening degree of the valve needs to be set to 22° before regulation by the at least one control component, so that the actual opening degree after regulation may reach 20°. Therefore, a regulation compensation quantity of the at least one control component for regulating the valve is +2°.

In some embodiments, the regulation compensation quantity of the at least one control component may be represented by a sequence composed of opposite counts of offset degrees of all covered valve(s) of the at least one control component.

For example, offset degrees corresponding to a covered valve 1, a covered valve 2, . . . , a covered valve n of a control component A are +1°, −3°, . . . , +2°, respectively, where n represents a total quantity of the covered valves of the control component A. A regulation compensation quantity of the control component A may be represented as (−1, +3, . . . , −2).

In some embodiments, determining, by a processor, the regulation compensation quantity of the at least one control component based on the correction period may include: executing step 241 and step 242 below within the correction period.

Step 241, controlling, based on a regulation parameter group, the at least one control component to regulate the at least one covered valve, to obtain a regulation gas data pair.

The regulation parameter group of the at least one control component may include expected opening degrees of the all covered valve(s) of the at least one control component. The regulation parameter group may be preset manually according to actual situations.

In some embodiments, the processor may control the at least one control component based on the regulation parameter group to adjust corresponding covered valve(s) from the current initial opening degree to the expected opening degree. After monitoring and obtaining the gas data after valve regulation, the processor may restore the opening degree of the covered valves to the initial opening degree.

The regulation gas data pair may include pipeline gas data before the valve regulation and pipeline gas data after the valve regulation. The pipeline gas data may include a gas flow rate, a gas flow velocity, a gas pressure, or the like, in a pipeline. One regulation by one control component corresponds to generating a plurality of regulation gas data pairs for a plurality of covered valves of one control component.

In some embodiments, the processor may obtain the pipeline gas data before the valve regulation and the pipeline gas data after the valve regulation based on a sensor deployed in the pipeline, thereby obtaining the regulation gas data pair.

Step 242, determining the regulation compensation quantity based on the regulation gas data pair and the regulation parameter group.

In some embodiments, the processor may determine the regulation compensation quantity based on the regulation gas data pair and the regulation parameter group in various ways.

For example, the processor may construct a plurality of second reference vectors based on a plurality of historical regulation gas data pairs and a plurality of historical regulation parameter groups corresponding to a plurality of historical control components in a plurality of historical regulations. For one control component in a current regulation, the processor may construct a second feature vector based on the regulation gas data pair and the regulation parameter group corresponding to one control component. The processor may determine a second reference vector having a greatest vector similarity with the second feature vector, and use the second reference vector as a second target vector. The processor may use a historical actual regulation compensation quantity corresponding to the second target vector as the regulation compensation quantity of the current control component.

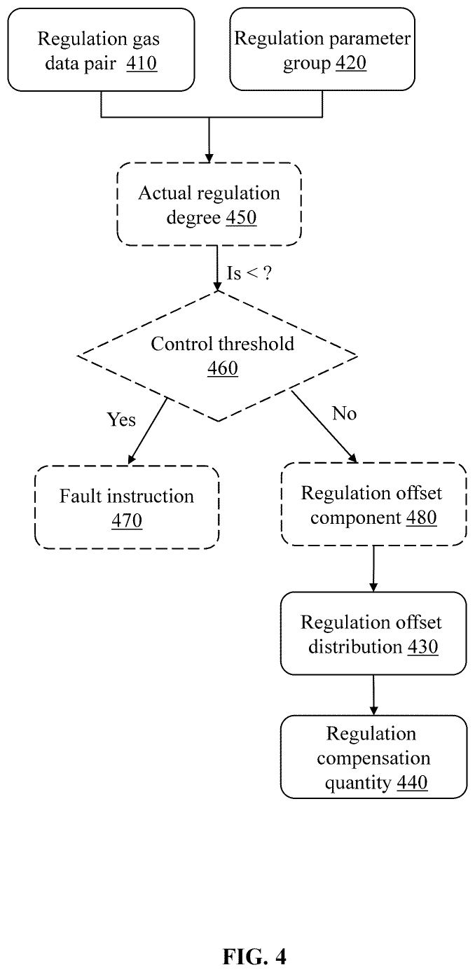

In some embodiments, the processor may further determine a regulation offset distribution of the at least one control component based on the regulation gas data pair and the regulation parameter group; and determine the regulation compensation quantity based on the regulation offset distribution. More descriptions about this part may be found in FIG. 4 and related descriptions thereof.

In some embodiments, the gas company management platform may upload the regulation compensation quantity to the government safety supervision management platform via the government safety supervision sensor network platform. A staff member of the government safety supervision management platform confirms the regulation compensation quantity to generate a correction confirmation instruction, and sends the correction confirmation instruction to the gas company management platform via the government safety supervision sensor network platform.

Step 250, in response to obtaining the correction confirmation instruction issued by the government safety supervision management platform, correcting the at least one control component based on the regulation compensation quantity.

The correction confirmation instruction refers to an instruction for confirming that the regulation compensation quantity is correct and for correcting the at least one control component.

In some embodiments, in response to obtaining the correction confirmation instruction, the processor may correct the at least one control component based on the regulation compensation quantity. For example, a regulation compensation quantity corresponding to a covered valve 1 of the control component A is +2°. An expected opening degree of the covered valve 1 of the control component A is increased by 2°.

In some embodiments of the present disclosure, by uploading the performance parameter and the deployment parameters to the government safety supervision management platform, supervision and control of the deployment process by the government may be promoted. Determining the deployment parameters based on the pipeline network information and the performance parameter of the at least one control component may enable the at least one control component to connect to as many valves as possible, improving resource utilization. Determining the regulation compensation quantity of the at least one control component based on the correction period and periodically correcting the at least one control component based on the regulation compensation quantity may timely avoid inaccurate regulation of valves by the at least one control component due to the fault of the at least one control component or the fault of the valve, ensuring that parameters such as the gas flow rate, the gas pressure, and temperature are within a set range, reducing gas control failure risks, thereby improving operational safety and achieving automated remote monitoring and intelligent control of gas.

FIG. 3 is an exemplary schematic diagram of determining deployment parameters according to some embodiments of the present disclosure.

In some embodiments, the pipeline network information may further include a valve type and a valve pipeline type. As shown in FIG. 3, the processor may determine a regulation-associated grouping 320 based on the pipeline network information 310; and determine the deployment parameters 340 based on the regulation-associated grouping 320 and the performance parameter 330 of the at least one control component.

The valve type may include a ball valve, a gate valve, a pressure reducing valve, or the like. The valve pipeline type refers to a pipeline type of the gas pipeline where a valve is located. The pipeline type may be classified in various ways. Merely by way of example, the pipeline type may be classified into a gas transmission pipeline, a gas distribution pipeline, a user access pipeline, etc., according to pipeline usage.

The regulation-associated grouping refers to a grouping category corresponding to a valve. In some embodiments, each regulation-associated grouping may include one or more valves.

In some embodiments, the processor may determine the regulation-associated grouping based on the pipeline network information through a clustering algorithm. The processor may construct a plurality of clustering vectors based on the pipeline network information, wherein one clustering vector is constituted by a valve position, a valve pipeline type, and a valve type of one valve; cluster the plurality of clustering vectors through the clustering algorithm to form a preset count of clustering clusters; divide valves in one clustering cluster into one regulation-associated grouping. The clustering algorithm may be a clustering algorithm with a preset count of clusters. For example, the clustering algorithm may be a K-means clustering algorithm, etc.

In some embodiments, the preset count of clustering clusters may be related to the maximum communication distance of the performance parameter. The processor may grid the current area using the maximum communication distance as a grid side length, and determine a count of grids after gridding as the preset count of clustering clusters. Related descriptions regarding the current area, the maximum communication distance of the performance parameter, etc., may be found in FIG. 2 and related descriptions thereof.

In some embodiments, the processor may determine the deployment parameters based on the regulation-associated grouping and the performance parameter of the at least one control component in various ways.

For example, the processor may count the valves in each regulation-associated grouping. For one regulation-associated grouping: in response to a determination that a count of the valves in the regulation-associated grouping is greater than a maximum valve connection count of the at least one control component, the processor may evenly divide an area corresponding to the regulation-associated grouping into a plurality of sub-areas according to a preset division condition, set centers of the plurality of sub-areas as deployment positions of a plurality of control components respectively, and set valves within the plurality of sub-areas as covered valves of corresponding control components respectively. The preset division condition is that a count of the sub-areas is minimized under the premise that a count of valves in each sub-area is not greater than the maximum valve connection count of the at least one control component.

For one regulation-associated grouping: in response to a determination that a count of valves in the regulation-associated grouping is less than or equal to a maximum valve connection count of the at least one control component, the processor may set a center of an area corresponding to the regulation-associated grouping as a deployment position of one control component, and set valves within the area as covered valves of the corresponding control component; determining the deployment parameters based on the deployment position and the covered valves corresponding to the regulation-associated grouping.

The area corresponding to the regulation-associated grouping may refer to an area capable of covering all valves within the regulation-associated grouping. Manners for selecting the area may be set manually or by a system. For example, a minimum rectangle capable of covering all valves within one regulation-associated grouping may be used as the area corresponding to the regulation-associated grouping.

In some embodiments, as shown in FIG. 3, the processor may generate a deployment position group 350 based on the regulation-associated grouping 320; construct a valve topology map 360 based on the deployment position group 350 and the performance parameter 330; and determine the deployment parameters 340 based on the valve topology map via a parameter determination model 370, wherein the parameter determination model is a machine learning model.

In some embodiments, one deployment position group may include a plurality of deployment positions corresponding to a plurality of control components.

In some embodiments, for one regulation-associated grouping, the processor may randomly select a plurality of points from an area corresponding to the regulation-associated grouping as a plurality of deployment positions of the at least one control component corresponding to the regulation-associated grouping; randomly select one deployment position from the plurality of deployment positions corresponding to the regulation-associated grouping to form one deployment position group; generate a plurality of deployment position groups based on a plurality of random selections.

The valve topology map refers to a graphical model illustrating the valves and relationships among the valves. In some embodiments, the valve topology map may include a plurality of nodes and a plurality of edges.

The nodes of the valve topology map include a first node, a second node, and a third node.

The first node is a valve. Node features of the first node may include a valve position, a valve type, and a pipeline type of a pipeline where the valve is located.

The second node is a deployment position.

The third node is a communication device. Node features of the third node may include a communication device position and communication parameters. The communication device may be used for pipeline network communication and may also be used for remote communication between the at least one control component and a remote device (e.g., the gas company management platform, etc.). The communication device may be a network base station, etc. The communication device position is a known position uploaded manually (e.g., a construction position of a network base station). The communication parameters may include a communication range, a communication bandwidth, a signal strength, etc.

In some embodiments, edges of the valve topology map includes a first type of edge, a second type of edge, a third type of edge, and a fourth type of edge; an edge feature of the first type of edge includes a communication distance between connected nodes; an edge feature of the second type of edge includes the communication distance between connected nodes; and an edge feature of the third type of edge includes pipeline gas data, the valve pipeline type, and a pipeline fluctuation characteristic.

The first type of edge is configured to connect the first node and the second node that satisfy a preset connection condition. The preset connection condition is that a communication distance between the first node and the second node is less than the maximum communication distance. In some embodiments, if communication distances between the first node and a plurality of second nodes are all less than the maximum communication distance, the first node is connected to a second node with a shortest communication distance, and a formed edge is used as the first type of edge, one first node corresponds to only one first type of edge. The communication distance between connected nodes may be represented by a straight-line distance between the nodes.

In some embodiments, when a first node M1 does not have a first type of edge with any second node, but a first node M2 in a same regulation-associated grouping as the first node M1 has a first type of edge with a second node W1, the first node M1 is connected to the second node W1 to form the second type of edge.

The third type of edge is configured to connect two first nodes that have an actual pipeline connection.

The fourth type of edge is configured to connect the third node and a second node within a communication range of the third node. A communication range of a communication device corresponding to the third node is generally large. Therefore, it may be considered that the third node in one valve topology map is connected to all second nodes via the fourth type of edge.

The pipeline fluctuation characteristic refers to a characteristic reflecting fluctuation of the gas data within the pipeline. In some embodiments, the processor may determine a ratio of a standard deviation to a mean of gas flow rates of the pipeline at a plurality of time points within a period of time as the pipeline fluctuation characteristic of the pipeline. A smaller ratio indicates a higher stability of the pipeline.

In some embodiments of the present disclosure, by constructing four types of edges, an information scope covered by the valve topology map is expanded. The valve topology map may not only include position information of the valves, but also display communication distances between the valves and pipeline information connected to each valve. This is beneficial for more accurately evaluating communication efficiency between the at least one control component and the valves and a state of the pipeline network, thereby optimizing a deployment and a regulation strategy of the at least one control component.

In some embodiments, the processor may determine edges and nodes of the valve topology map based on the pipeline network information, the deployment position group, and the performance parameter. One deployment position group corresponds to one valve topology map.

The parameter determination model refers to a model for determining the deployment parameters. In some embodiments, the parameter determination model may be a machine learning model. For example, the parameter determination model may be a graph neural network (GNN), or the like.

In some embodiments, an input of the parameter determination model may include the valve topology map, and an output of the parameter determination model may include a communication delay of the first type of edge and a communication delay of the second type of edge in the valve topology map.

In some embodiments, the communication delay may be represented by a time required for signal transmission.

In some embodiments, the parameter determination model may be obtained through training in a plurality of ways. For example, the parameter determination model may be obtained through training using a plurality of training samples with training labels, etc.

The training sample and the training label may be obtained based on historical data. For example, the training sample may be a sample valve topology map constructed based on the historical data. The historical data includes historical pipeline network information, a historical deployment position group, and a historical performance parameter of at least one historical control component. A construction manner of the sample valve topology map may refer to the construction process of the valve topology map described above. The training label corresponding to the training sample is a historical actual communication delay of a sample first type of edge and a historical actual communication delay of a sample second type of edge corresponding to the sample valve topology map. The training label may be manually annotated.

In some embodiments, the processor may input the sample valve topology map into an initial parameter determination model; construct a loss function based on a communication delay of a first type of edge and a communication delay of a second type of edge output by the initial parameter determination model and the training label; update the initial parameter determination model based on the loss function. When a preset condition is satisfied, training of the initial parameter determination model is completed, and a trained parameter determination model is obtained. The preset condition may be convergence of the loss function, a count of iterations reaching a threshold, etc.

In some embodiments, training of the parameter determination model includes training based on a training set, validating based on a validation set, and testing based on a test set; wherein the training set, the validation set, and the test set are a dataset composed of historical pipeline network information, a historical deployment position group, and a historical performance parameter of a historical control component; data amounts of the training set, the validation set, and the test set constitute a preset ratio, and there is no data overlap among the training set, the validation set, and the test set; and a sample learning rate in model training is related to a sample accident probability.

The training set refers to a dataset used for training internal parameters of a model.

The validation set refers to a dataset used for validating a state and a convergence situation of a model during a training process. The validation set may be used for determining a hyperparameter, monitoring whether the model is overfitting, and determining when to stop training the model.

The test set refers to a dataset used for testing a generalization ability of a model. After using the validation set to determine the hyperparameter and using the training set to adjust the internal parameters, the test set may be configured to determine whether the model operates and a performance of the model.

In some embodiments, the historical pipeline network information, the historical deployment position group, and the historical performance parameter of the at least one historical control component may constitute a data group, which is configured to obtain a corresponding sample valve topology map. The training set, the validation set, and the test set are each composed of a plurality of data groups.

The preset ratio refers to a preset ratio of data volumes included in the training set, the validation set, and the test set, respectively. In some embodiments, the preset ratio may be set by the system by default or set by a technician based on experience. For example, the preset ratio may be 8:1:1.

The data overlap refers to existence of identical data in different sets, i.e., the same data is used in a plurality of sets. In some embodiments, the training set, the validation set, and the test set have no data overlap. That is, a data group is only included in one of the training set, the validation set, and the test set.

In some embodiments, a sample learning rate in the model training may be related to the sample accident probability. For example, the greater the sample accident probability, the greater the sample learning rate.

In some embodiments, for each sample valve topology map, the processor may calculate an interval duration between an accident occurrence time and a regulation time for each accident occurring in an area corresponding to the sample valve topology map, and determine a result of normalizing a ratio of an average value of interval durations corresponding to a plurality of accidents to a preset time length as the sample accident probability.

The accident occurrence time refers to a time point when the accident occurs in the area corresponding to the sample valve topology map. The regulation time refers to a time point when a valve in the sample valve topology map is regulated after the accident occurs. In some embodiments, the processor may directly obtain the accident occurrence time and the regulation time of the each accident corresponding to the sample valve topology map from the historical data. The preset time length may be set by the processor by default or set manually based on experience. For example, the preset time length may be an average value of interval durations between a plurality of historical accident occurrence times in the historical data.

In some embodiments of the present disclosure, by dividing the historical data into the training set, the validation set, and the test set to train the model in stages, and dynamically adjusting the sample learning rate according to the sample accident probability, an overfitting problem caused by the data overlap is avoided, accuracy and adaptability of the model in predicting the deployment parameters are improved.

In some embodiments, the processor may input a plurality of valve topology maps corresponding to a plurality of deployment position groups into the parameter determination model; and output the corresponding communication delay of the first type of edge and the corresponding communication delay of the second type of edge, respectively. The processor may screen out a valve topology map satisfying a screening condition based on a model output result; determine at least one second node included in the valve topology map as the at least one deployment position of the at least one control component; determine a first node connected to each second node through the first type of edge or the second type of edge as the at least one covered valve of a corresponding control component; combine the at least one deployment position and the at least one covered valve as the deployment parameters.

The screening condition may be that, in the valve topology map, the communication delay of the first type of edge exceeding a preset ratio is less than a communication delay threshold and the communication delay of the second type of edge exceeding the preset ratio is less than the communication delay threshold. The preset ratio and the communication delay threshold may be set by the processor by default or set by a technician based on experience.

In some embodiments of the present disclosure, by constructing the valve topology map in combination with the regulation-associated grouping and the performance parameter of the at least one control component, valve relationships and characteristics within the pipeline network are graphically presented. This helps enhance understanding of an overall structure of the pipeline network during regulation work. Furthermore, the machine learning model is utilized to achieve precise determination of the deployment parameters. An intelligent level of decision-making is improved. Scientific nature and effectiveness of control component arrangement are ensured.

In some embodiments of the present disclosure, by grouping based on the valve position, the valve pipeline type, and the valve type of the valves, the valves may be managed separately and independently for a specific function or an area. In combination with the grouping and the performance parameter of the at least one control component, the deployment parameters are determined. This ensures that the at least one control component may effectively regulate the covered valves while avoiding resource waste. Regulation accuracy and resource utilization efficiency of the gas pipeline network are improved.

FIG. 4 is an exemplary schematic diagram of determining a regulation compensation quantity according to some embodiments of the present disclosure.

In some embodiments, as shown in FIG. 4, the processor may determine a regulation offset distribution 430 of the at least one control component based on the regulation gas data pair 410 and the regulation parameter group 420; and determine the regulation compensation quantity 440 based on the regulation offset distribution 430. The regulation offset distribution includes an offset degree for each of the covered valves of the at least one control component. More descriptions regarding the regulation gas data pair, the regulation parameter group, and the regulation compensation quantity may be found in FIG. 2 and related descriptions thereof.

In some embodiments, the regulation offset distribution includes the offset degree for the each of the covered valves of the at least one control component. More descriptions of the offset degree may be found in FIG. 2 and related descriptions thereof.

In some embodiments, a processor may determine the regulation offset distribution of the at least one control component based on the regulation gas data pair and the regulation parameter group in various ways.

For example, for each covered valve of the at least one control component, the processor may determine a gas flow rate change rate and a gas flow velocity change rate before and after valve adjustment based on the regulation gas data pair. The gas flow rate change rate is represented by a ratio of an absolute value of a difference between a pipeline gas flow rate before regulation and a pipeline gas flow rate after regulation to the pipeline gas flow rate before regulation. The gas flow velocity change rate is determined similarly.

Based on the gas flow rate change rate and the gas flow velocity change rate, an actual change amplitude of the covered valve is determined by querying a preset relationship table. The actual change amplitude refers to an actual change amount of a valve opening degree before and after actual regulation. The actual change amplitude is represented by subtracting an initial opening degree of the covered valve before regulation from an actual opening degree of the covered valve after regulation. An actual opening degree of the valve after regulation is obtained by adding the actual change amplitude to a current opening degree of the valve before regulation. An expected opening degree of the valve is obtained based on the regulation parameter group. A difference between the actual opening degree and the expected opening degree is determined as an offset amount of the covered valve. An offset amount of each covered valve of each control component of the at least one control component is calculated to determine the regulation offset distribution.

The preset relationship table may be constructed manually through experiments. For example, a technician may introduce gas into an experimental pipeline and regulate an opening degree of an experimental valve a plurality of times. The experimental valve is a valve that is not rusted, not aged, and regulates normally. During each experiment, a valve change amplitude of the experimental valve (e.g., a valve rotation angle) is recorded, along with a pipeline gas flow rate and a pipeline gas flow velocity before regulation and a pipeline gas flow rate and a pipeline gas flow velocity after regulation. Based on the pipeline gas flow rate before regulation and the pipeline gas flow rate after regulation, the gas flow rate change rate is calculated. The gas flow velocity change rate is obtained similarly. Based on a correspondence among the gas flow rate change rate, the gas flow velocity change rate, and the valve change amplitude of the experimental valve in each experiment, the preset relationship table is constructed.

In some embodiments, as shown in FIG. 4, for the each control component of the at least one control component, the processor may determine an actual regulation degree 450 of the at least one control component based on the regulation gas data pair 410 and the regulation parameter group 420; in response to the actual regulation degree 450 being less than a control threshold 460, determine a fault instruction 470, and send the fault instruction to the at least one personnel interaction device; in response to the actual regulation degree 450 being greater than or equal to the control threshold 460, determine a regulation offset component 480 of the at least one control component based on the regulation gas data pair 410 and the regulation parameter group 420; and determine the regulation offset distribution 430 based on the regulation offset component 480 of the each control component of the at least one control component.

The actual regulation degree refers to a parameter for measuring a regulation effect of the at least one control component. The greater the actual regulation degree, the better control effect of the at least one control component on the covered valves.

In some embodiments, the processor may determine an actual change amplitude of each of the covered valves of the at least one control component based on the regulation gas data pair; determine an expected change amplitude of the each of the covered valves of the at least one control component based on the regulation parameter group; and determine the actual regulation degree of the each of the at least one control component by weighting the actual change amplitude and the expected change amplitude, wherein a weight is related to a pipeline fluctuation characteristic of a pipeline where the valve is located.

More descriptions regarding determining the actual change amplitude based on the regulation gas data pair may be found in the related descriptions above.

The expected change amplitude refers to an expected change amount of a valve opening degree before and after expected regulation.

In some embodiments, the processor may obtain an expected opening degree of the covered valve after regulation based on the regulation parameter group. A difference between the expected opening degree after regulation and a current actual opening degree before regulation is used as the expected change amplitude.

In some embodiments, the processor may determine the actual regulation degree of the each of the at least one control component by weighting based on actual change amplitudes and expected change amplitudes of a plurality of covered valves of the at least one control component. Merely by way of example, an actual regulation degree of the control component A may be calculated using the following formula (1):

$${R}_{A} = {\sum }_{i = 1}^{n} \frac{{k}_{i} * {f}_{i}}{{e}_{i}} \qquad ( 1 )$$

Where R_{A} is the actual regulation degree of the control component A, kᵢ is a weight of an i-th covered valve of the control component A, fᵢ is an actual change amplitude of the i-th covered valve of the control component A, eᵢ is an expected change amplitude of the i-th covered valve of the control component A, and n is a quantity of covered valves of the control component A.

In some embodiments, the weight of the covered valves is related to the pipeline fluctuation characteristic of the pipeline where the valve is located. The greater the pipeline fluctuation characteristic of the pipeline where the valve is located, the smaller the weight corresponding to the covered valve. More descriptions regarding the pipeline fluctuation characteristic may be found in FIG. 3 and related descriptions thereof.

In some embodiments of the present disclosure, based on the regulation gas data pair and a pairing relationship between the regulation gas data pair and a valve opening degree, the actual change amplitude of the covered valves may be accurately determined; determining the actual regulation degree of the at least one control component by weighting the actual change amplitude and the expected change amplitude achieves quantification of regulation effectiveness;

determining the weight based on the pipeline fluctuation characteristic may reduce an impact of a gas pipeline with larger gas fluctuation on gas data, thereby improving the overall reliability of the actual regulation degree.

In some embodiments, the control threshold may be determined by an average value of valve criticalities of the plurality of covered valves of the at least one control component. The greater the average value of the valve criticalities, the greater the control threshold.

The valve criticality refers to an importance degree of the valve. In some embodiments, the valve criticality of the covered valve may be obtained by calculation using the following formula (2):

$$S = {q}_{1} \times b + {q}_{2} \times h \qquad ( 2 )$$

Where S is the valve criticality of the covered valve, b is an associated downstream branch count of the covered valve, h is a historical maintenance timeliness of the covered valve, and q₁ and q₂ are preset constants.

The associated downstream branch count refers to a quantity of downstream valves directly connected to the covered valve. The historical maintenance timeliness may be negatively correlated with an average response duration. The average response duration refers to an average value of response durations from generation of a fault instruction to commencement of maintenance in a plurality of historical faults of the covered valve.

The fault instruction may include a control component that triggers a fault alarm and a corresponding covered valve.

In some embodiments, in response to the actual regulation degree of the each of the at least one control component being less than the control threshold, the processor may determine that a regulation abnormality exists or performance of the each of the at least one control component degrades, to generate the fault instruction. The fault instruction is sent to the personnel interaction device of the gas maintenance object platform via the gas company sensor network platform to arrange the staff member for fault investigation and maintenance.

The regulation offset component refers to a component corresponding to the each of the at least one control component in the regulation offset distribution.

In some embodiments, in response to the actual regulation degree of the each of the at least one control component being greater than or equal to the control threshold, the processor may determine an actual opening degree and an expected opening degree of each covered valve of the each of the at least one control component based on the regulation gas data pair and the regulation parameter group; a difference between the actual opening degree and the expected opening degree is determined as the offset amount of the covered valve, and the offset amount of the each covered valve of the each of the at least one control component is calculated to determine the regulation offset component. More descriptions regarding the above process may be found in the related descriptions above.

In some embodiments, the processor may combine regulation offset components of all control components that do not generate the fault instruction to determine the regulation offset distribution.

In some embodiments of the present disclosure, determining the actual regulation degree based on the regulation gas data pair and the regulation parameter group achieves quantification of a regulation effect of the each of the at least one control component. Meanwhile, by comparing the actual regulation degree with the control threshold, an abnormal situation may be quickly determined when the actual regulation degree is too small, and the fault instruction may be issued promptly, thereby accelerating a fault response and maintenance process and reducing potential safety hazards. For components that meet or exceed the control threshold, a regulation strategy is optimized by calculating the regulation offset component, ensuring control precision and improving operational efficiency and reliability of the entire gas pipeline network.

In some embodiments, the processor may determine the offset degree for each of the covered valves of the each of the at least one control component based on the regulation offset distribution; and an opposite count of the offset degree is used as the regulation compensation quantity.

In some embodiments of the present disclosure, determining the regulation offset distribution based on the regulation gas data pair may determine a deviation of the each of the at least one control component, laying a foundation for a correction process; determining the regulation compensation quantity based on the regulation offset distribution enables the IoT system to precisely correct regulation deviation of the IoT system during operation. The regulation compensation quantity may reduce gas control failure problems caused by the fault of the control component or the fault of the valve, facilitating automated remote regulation and control of gas and improving stability and safety of the gas pipeline network.

One or more embodiments of the present disclosure provide a non-transitory computer-readable storage medium, wherein the storage medium stores computer instructions, and when a computer reads the computer instructions in the storage medium, the computer executes the method for remote control supervision of valves in the smart gas pipeline network.

The embodiments in the present disclosure are merely for illustration and description and do not limit the scope of application of the present disclosure. For those skilled in the art, various modifications and changes that may be made under the guidance of the present disclosure still fall within the scope of the present disclosure.

In addition, certain features, structures, or characteristics in one or more embodiments of the present disclosure may be appropriately combined.

In some embodiments, numbers describing components and attribute quantities are used. It should be understood that such numbers configured to describe the embodiments, in some examples, are modified by modifiers such as “approximately,” “approximate,” or “substantially.” Unless otherwise stated, “approximately,” “approximate,” or “substantially” indicates that the described number allows a variation of +20%. Accordingly, in some embodiments, numerical parameters used in the specification and claims are approximate values. The approximate values may change according to characteristics required by individual embodiments. In some embodiments, the numerical parameters should consider specified significant digits and adopt a general method of digit retention. Although numerical ranges and parameters configured to confirm a breadth of a scope in some embodiments of the present disclosure are approximate values, in specific embodiments, setting of such numerical values is as precise as possible within a feasible range.

If any description, definition, and/or usage of terms in the accompanying materials of the present disclosure is inconsistent with or conflicts with the description, definition, and/or usage of terms in the present disclosure, the description, definition, and/or usage of terms in the present disclosure shall prevail.

What is claimed is:

1. An Internet of Things (IoT) system for remote control and supervision of valves in a smart gas pipeline network, wherein the IoT system includes a government safety supervision management platform, a government safety supervision sensor network platform, a government safety supervision object platform, a gas company sensor network platform, a gas equipment object platform, and a gas maintenance object platform;
wherein the government safety supervision object platform includes a gas company management platform, the gas equipment object platform includes at least one control component, and the gas maintenance object platform includes at least one personnel interaction device;
wherein the gas company management platform is configured to:
obtain pipeline network information and a performance parameter of the at least one control component from the gas equipment object platform via the gas company sensor network platform, and upload the performance parameter to the government safety supervision management platform via the government safety supervision sensor network platform;
in response to obtaining a parameter confirmation instruction issued by the government safety supervision management platform, determine deployment parameters based on the pipeline network information and the performance parameter, and upload the deployment parameters to the government safety supervision management platform via the government safety supervision sensor network platform; wherein the deployment parameters include at least one deployment position and at least one covered valve of the at least one control component;
in response to obtaining a deployment confirmation instruction issued by the government safety supervision management platform, send the deployment parameters to the gas maintenance object platform via the gas company sensor network platform, to arrange a staff member for component deployment;
after completing the deployment, determine a regulation compensation quantity of the at least one control component based on a correction period, and upload the regulation compensation quantity to the government safety supervision management platform via the government safety supervision sensor network platform; and
in response to obtaining a correction confirmation instruction issued by the government safety supervision management platform, correct the at least one control component based on the regulation compensation quantity;
wherein the gas company management platform, within the correction period, performs the following operations:
controlling, based on a regulation parameter group, the at least one control component to regulate the at least one covered valve, to obtain a regulation gas data pair; and
determining the regulation compensation quantity based on the regulation gas data pair and the regulation parameter group.

2. The IoT system according to claim 1, wherein the pipeline network information includes a valve type and a valve pipeline type, and the gas company management platform is further configured to:
determine a regulation-associated grouping based on the pipeline network information; and
determine the deployment parameters based on the regulation-associated grouping and the performance parameter of the at least one control component.

3. The IoT system according to claim 2, wherein the gas company management platform is further configured to:
generate a deployment position group based on the regulation-associated grouping;
construct a valve topology map based on the deployment position group and the performance parameter; and
determine the deployment parameters based on the valve topology map via a parameter determination model, wherein the parameter determination model is a machine learning model.

4. The IoT system according to claim 3, wherein training of the parameter determination model includes training based on a training set, validating based on a validation set, and testing based on a test set;
wherein the training set, the validation set, and the test set are a dataset composed of historical pipeline network information, a historical deployment position group, and a historical performance parameter of a historical control component; data amounts of the training set, the validation set, and the test set constitute a preset ratio, and there is no data overlap among the training set, the validation set, and the test set; and a sample learning rate in model training is related to a sample accident probability.

5. The IoT system according to claim 3, wherein edges of the valve topology map includes a first type of edge, a second type of edge, a third type of edge, and a fourth type of edge; an edge feature of the first type of edge includes a communication distance between connected nodes; an edge feature of the second type of edge includes the communication distance between connected nodes; and an edge feature of the third type of edge includes pipeline gas data, the valve pipeline type, and a pipeline fluctuation characteristic.

6. The IoT system according to claim 1, wherein the gas company management platform is further configured to:
determine a regulation offset distribution of the at least one control component based on the regulation gas data pair and the regulation parameter group, wherein the regulation offset distribution includes an offset degree for each of the at least one covered valve of the at least one control component; and
determine the regulation compensation quantity based on the regulation offset distribution.

7. The IoT system according to claim 6, wherein the gas company management platform is further configured to:
for each control component of the at least one control component,
determine an actual regulation degree of the control component based on the regulation gas data pair and the regulation parameter group;
in response to the actual regulation degree being less than a control threshold, determine a fault instruction, and send the fault instruction to the at least one personnel interaction device;
in response to the actual regulation degree being greater than or equal to the control threshold, determine a regulation offset component of the control component based on the regulation gas data pair and the regulation parameter group; and
determine the regulation offset distribution based on the regulation offset component of the each control component of the at least one control component.

8. The IoT system according to claim 7, wherein the gas company management platform is further configured to:
determine an actual change amplitude of each of the at least one covered valve of the at least one control component based on the regulation gas data pair;
determine an expected change amplitude of the each of the at least one covered valve of the at least one control component based on the regulation parameter group; and
determine the actual regulation degree of the each of the at least one control component by weighting the actual change amplitude and the expected change amplitude, wherein a weight is related to a pipeline fluctuation characteristic of a pipeline where the valve is located.

9. A method for remote control and supervision of valves in a smart gas pipeline network, wherein the method is implemented based on an Internet of Things (IoT) system for remote control and supervision of valves in a smart gas pipeline network, the IT system including a government safety supervision management platform, a government safety supervision sensor network platform, a government safety supervision object platform, a gas company sensor network platform, a gas equipment object platform, and a gas maintenance object platform;
wherein the government safety supervision object platform includes a gas company management platform, the gas equipment object platform includes at least one control component, and the gas maintenance object platform includes at least one personnel interaction device;
wherein the method is performed by the gas company management platform and comprises:
obtain pipeline network information and a performance parameter of the at least one control component from the gas equipment object platform via the gas company sensor network platform, and upload the performance parameter to the government safety supervision management platform via the government safety supervision sensor network platform;
in response to obtaining a parameter confirmation instruction issued by the government safety supervision management platform, determine deployment parameters based on the pipeline network information and the performance parameter, and upload the deployment parameters to the government safety supervision management platform via the government safety supervision sensor network platform; wherein the deployment parameters includes at least one deployment position and at least one covered valves of each of at least one control component;
in response to obtaining a deployment confirmation instruction issued by the government safety supervision management platform, send the deployment parameters to the gas maintenance object platform via the gas company sensor network platform, to arrange a staff member for component deployment;
after completing the deployment, determine a regulation compensation quantity of the at least one control component based on a correction period, and upload the regulation compensation quantity to the government safety supervision management platform via the government safety supervision sensor network platform; and
in response to obtaining a correction confirmation instruction issued by the government safety supervision management platform, correcting the at least one control component based on the regulation compensation quantity;
wherein the determining a regulation compensation quantity of the at least one control component based on a correction period includes:
within the correction period, performing the following operations:
controlling, based on a regulation parameter group, the at least one control component to regulate the at least one covered valve, to obtain a regulation gas data pair; and
determining the regulation compensation quantity based on the regulation gas data pair and the regulation parameter group.

10. The method according to claim 9, wherein the pipeline network information includes a valve type and a valve pipeline type, and the determining deployment parameters based on the pipeline network information and the performance parameter includes:
determining a regulation-associated grouping based on the pipeline network information; and
determining the deployment parameters based on the regulation-associated grouping and the performance parameter of the at least one control component.

11. The method according to claim 10, wherein the determining the deployment parameters based on the regulation-associated grouping and the performance parameter of the at least one control component includes:
generating a deployment position group based on the regulation-associated grouping;
constructing a valve topology map based on the deployment position group and the performance parameter; and
determining the deployment parameters through a parameter determination model based on the valve topology map, wherein the parameter determination model is a machine learning model.

12. The method according to claim 11, wherein training of the parameter determination model includes training based on a training set, validating based on a validation set, and testing based on a test set;
wherein the training set, the validation set, and the test set are a dataset composed of historical pipeline network information, a historical deployment position group, and a historical performance parameter of a historical control component; data amounts of the training set, the validation set, and the test set constitute a preset ratio, and there is no data overlap among the training set, the validation set, and the test set; and a sample learning rate in model training is related to a sample accident probability.

13. The method according to claim 11, wherein edges of the valve topology map includes a first type of edge, a second type of edge, a third type of edge, and a fourth type of edge; an edge feature of the first type of edge includes a communication distance between connected nodes; an edge feature of the second type of edge includes the communication distance between connected nodes; and an edge feature of the third type of edge includes pipeline gas data, the valve pipeline type, and a pipeline fluctuation characteristic.

14. The method according to claim 9, wherein the determining the regulation compensation quantity based on the regulation gas data pair and the regulation parameter group includes:
determining a regulation offset distribution of the at least one control component based on the regulation gas data pair and the regulation parameter group; wherein the regulation offset distribution includes an offset degree for each of the at least one covered valve of the at least one control component; and
determining the regulation compensation quantity based on the regulation offset distribution.

15. The method according to claim 14, wherein the determining a regulation offset distribution of the at least one control component based on the regulation gas data pair and the regulation parameter group includes:
for each control component of the at least one control component,
determining an actual regulation degree of the control component based on the regulation gas data pair and the regulation parameter group;
in response to the actual regulation degree being less than a control threshold, determining a fault instruction, and send the fault instruction to the at least one personnel interaction device;
in response to the actual regulation degree being greater than or equal to the control threshold, determining a regulation offset component of the control component based on the regulation gas data pair and the regulation parameter group; and
determining the regulation offset distribution based on the regulation offset component of the each control component of the at least one control component.

16. The method according to claim 15, wherein the determining an actual regulation degree of the each of at least one control component based on the regulation gas data pair and the regulation parameter group includes:
determining an actual change amplitude of each of the at least one covered valve of the at least one control component based on the regulation gas data pair;
determining an expected change amplitude of the each of the at least one covered valve of the at least one control component based on the regulation parameter group; and
determining the actual regulation degree of the each of at least one control component by weighting the actual change amplitude and the expected change amplitude, wherein a weight is related to a pipeline fluctuation characteristic of a pipeline where the valve is located.

17. A non-transitory computer-readable storage medium, wherein the storage medium stores computer instructions, and when a computer reads the computer instructions in the storage medium, the computer executes the method according to claim 9.
